(19) United States
(12) Patent Application Publication
(10) Pub. No.: US 2026/0261887 A1
(43) Pub. Date: Sep. 3, 2026

(54) ENHANCEMENTS ON WIRELESS TIME SYNCHRONIZATION FOR RANGING

(71) Applicant: QUALCOMM Incorporated, San Diego, CA (US)

(72) Inventor: Varun Amar REDDY, San Diego, CA (US)

(21) Appl. No.: 19/069,028

(22) Filed: Mar. 3, 2025

(51) Int. Cl. H04W 24/08; H04W 24/02; H04W 64/00

(52) U.S. Cl. CPC H04W 24/08; H04W 24/02; H04W 64/00

(57) ABSTRACT

Aspects presented herein may enable anchors to provide confidence metrics associated with synchronization accuracy, thereby enabling tags to implement positioning algorithm(s) that consider the confidence metrics to improve the ranging performance. In one aspect, a first wireless device transmits, to a second wireless device, a set of parameters that includes at least one of: (1) a location accuracy of the first wireless device, (2) a ranging accuracy between the first wireless device and one or more wireless devices, (3) a clock stability of the first wireless device, (4) one or more hardware calibration errors associated with the first wireless device, or (5) a set of confidence metric formulation options. The first wireless device estimates a confidence metric related to a synchronization accuracy of the first wireless device based on at least one of the set of parameters. The first wireless device transmits the confidence metric for positioning of a UE.

### TECHNICAL FIELD

The present disclosure relates generally to communication systems, and more particularly, to a wireless communication involving positioning and ranging.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning (e.g., including tracking and/or ranging) protocols and techniques that enable mobile network operators to provide high-accuracy location/tracking/ranging services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus transmits, to a second wireless device, a set of parameters that includes at least one of: (1) a location accuracy of the first wireless device, (2) a ranging accuracy between the first wireless device and one or more wireless devices, (3) a clock stability of the first wireless device, (4) one or more hardware calibration errors associated with the first wireless device, or (5) a set of confidence metric formulation options. The apparatus estimates a confidence metric related to a synchronization accuracy of the first wireless device based on at least one of the set of parameters. The apparatus transmits the confidence metric for positioning of a user equipment (UE).

In an aspect of the disclosure, a method, a computer-readable medium, and an apparatus are provided. The apparatus receives, from a first wireless device, a set of parameters that includes at least one of: (1) a location accuracy of the first wireless device, (2) a ranging accuracy between the first wireless device and one or more wireless devices, (3) a clock stability of the first wireless device, (4) one or more hardware calibration errors associated with the first wireless device, or (5) a set of confidence metric formulation options. The apparatus estimates a confidence metric related to a synchronization accuracy of the second wireless device based on at least one of the set of parameters. The apparatus transmits the confidence metric for positioning of a UE.

In an aspect of the disclosure, a method, a computer-readable medium, and an apparatus are provided. The apparatus receives, from each wireless device in a set of wireless devices, a confidence metric related to a synchronization accuracy of the wireless device. The apparatus estimates a position of the UE based on using one or more confidence metrics of one or more wireless devices in the set of wireless devices.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5A is a diagram illustrating example roles for an ultra-wideband (UWB) ranging operation in accordance with various aspects of the present disclosure.

FIG. 5B is a diagram illustrating example roles for an UWB ranging operation in accordance with various aspects of the present disclosure.

FIG. 6 is a diagram illustrating an example time-scheduled or contention-free ranging in UWB in accordance with various aspects of the present disclosure.

FIG. 7A is a diagram illustrating an example contention-based ranging in UWB in accordance with various aspects of the present disclosure.

FIG. 7B is a diagram illustrating an example contention-based ranging in UWB in accordance with various aspects of the present disclosure.

FIG. 8 is a diagram illustrating an example hybrid-based ranging in UWB in accordance with various aspects of the present disclosure.

FIG. 9 is a diagram illustrating an example UWB ranging based on downlink-time difference of arrival (DL-TDoA) in accordance with various aspects of the present disclosure.

FIG. 10 is a diagram illustrating an example of associating different clusters with different ranging rounds in accordance with various aspects of the present disclosure.

FIG. 11 is a diagram illustrating an example transmission of blink messages in accordance with various aspects of the present disclosure.

FIG. 12 is a communication flow illustrating an example of anchors providing their uncertainties and/or confidence metrics related to time synchronization based on a synchronization accuracy to improve ranging performance in accordance with various aspects of the present disclosure.

FIG. 13 is a flowchart of a method of wireless communication.

FIG. 14 is a diagram illustrating an example of a hardware implementation for an example apparatus and/or network entity.

FIG. 15 is a flowchart of a method of wireless communication.

FIG. 16 is a diagram illustrating an example of a hardware implementation for an example apparatus and/or network entity.

FIG. 17 is a flowchart of a method of wireless communication.

FIG. 18 is a diagram illustrating an example of a hardware implementation for an example apparatus and/or network entity.

### DETAILED DESCRIPTION

Various aspects relate generally to wireless communication and more particularly to tracking and/or ranging based on wireless communication. Some aspects more specifically relate to improve/enhance the overall performance of ranging, such as ultra-wideband (UWB) ranging. Aspects presented herein may enable one or more anchors to calculate and broadcast (e.g., in the case of downlink-time difference of arrival (DL-TDoA)) an uncertainty value (and/or a confidence metric) associated with the synchronization accuracy, thereby enabling the tags to implement positioning algorithms that are capable of considering or taking advantage of these uncertainty values and/or confidence metrics, and also perform more informed anchor-selection strategies. Aspects presented herein may also enable synchronization anchors (i.e., anchors that are configured/selected to provide reference times) to be adaptively updated. In addition, aspects presented herein may enable the impact of the time reference considered by an anchor (e.g., Δt_{B} discussed below) to be reduced, which in turn leading to a higher position estimation accuracy (e.g., enabling round trip time (RTT) filtering over time, joint optimization of synchronization error and anchor node locations, etc.). Aspects presented herein may apply to various types of ranging technologies and are not limited to UWB ranging (e.g., may also be applicable to Wi-Fi ranging, Bluetooth ranging, network-based ranging, sidelink ranging, etc.).

Anchors, such as UWB anchors, may rely on over the air wireless time synchronization which may suffer from inaccuracies in propagation delays and clock offset/drift calculations. Aspects presented herein enables a synchronization anchor to include in its ranging control message (RCM) to other anchors, parameters, along with equations/methods that use the parameters to calculate a confidence metric for the anchor's synchronization accuracy. The anchors may then include this confidence metric for the synchronization accuracy in their downlink time different of arrival (TDoA) message (DTM) messages to tags/location servers. This information may then be used during position estimation of a tag to select anchors with the highest confidence metric for positioning or apply a synchronization error correction term to TDoA measurements.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

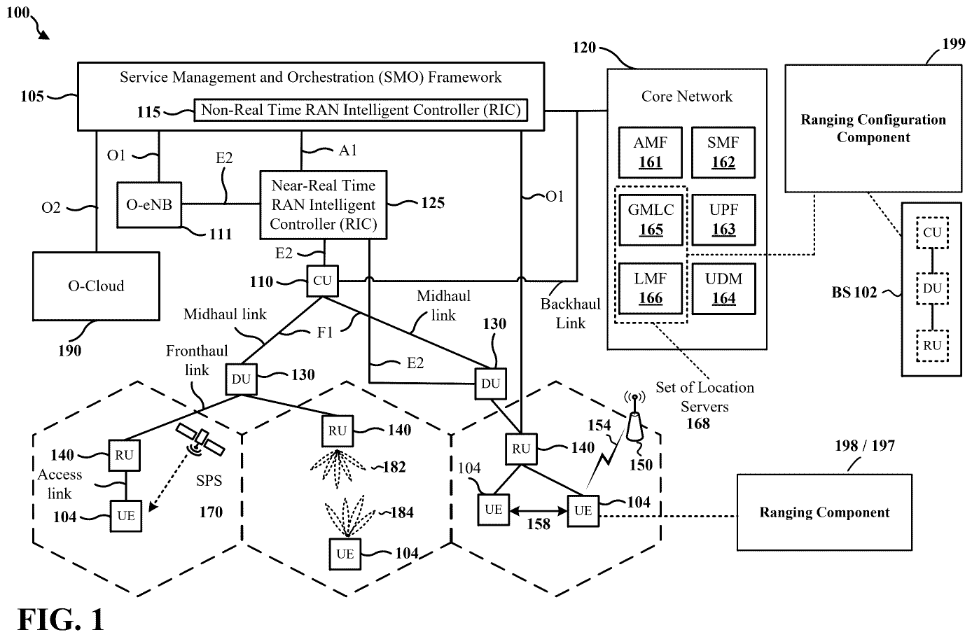

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a ranging component 198 that may be configured to transmit, to a second wireless device, a set of parameters that includes at least one of: (1) a location accuracy of the first wireless device, (2) a ranging accuracy between the first wireless device and one or more wireless devices, (3) a clock stability of the first wireless device, (4) one or more hardware calibration errors associated with the first wireless device, or (5) a set of confidence metric formulation options; estimate a confidence metric related to a synchronization accuracy of the first wireless device based on at least one of the set of parameters; and transmit the confidence metric for positioning of a UE. In certain aspects (in addition or as an alternative), the ranging component 198 may be configured to receive, from a first wireless device, a set of parameters that includes at least one of: (1) a location accuracy of the first wireless device, (2) a ranging accuracy between the first wireless device and one or more wireless devices, (3) a clock stability of the first wireless device, (4) one or more hardware calibration errors associated with the first wireless device, or (5) a set of confidence metric formulation options; estimate a confidence metric related to a synchronization accuracy of the second wireless device based on at least one of the set of parameters; and transmit the confidence metric for positioning of a UE. In certain aspects, the UE 104 may include a ranging component 197 that may be configured to receive, from each wireless device in a set of wireless devices, a confidence metric related to a synchronization accuracy of the wireless device; and estimate a position of the UE based on using one or more confidence metrics of one or more wireless devices in the set of wireless devices. In certain aspects, the base station 102 and/or the one or more location servers 168 may have a ranging configuration component 199 that may be configured to provide ranging parameters for the UEs, estimate position for the UEs, or select/manage anchors for the UEs.

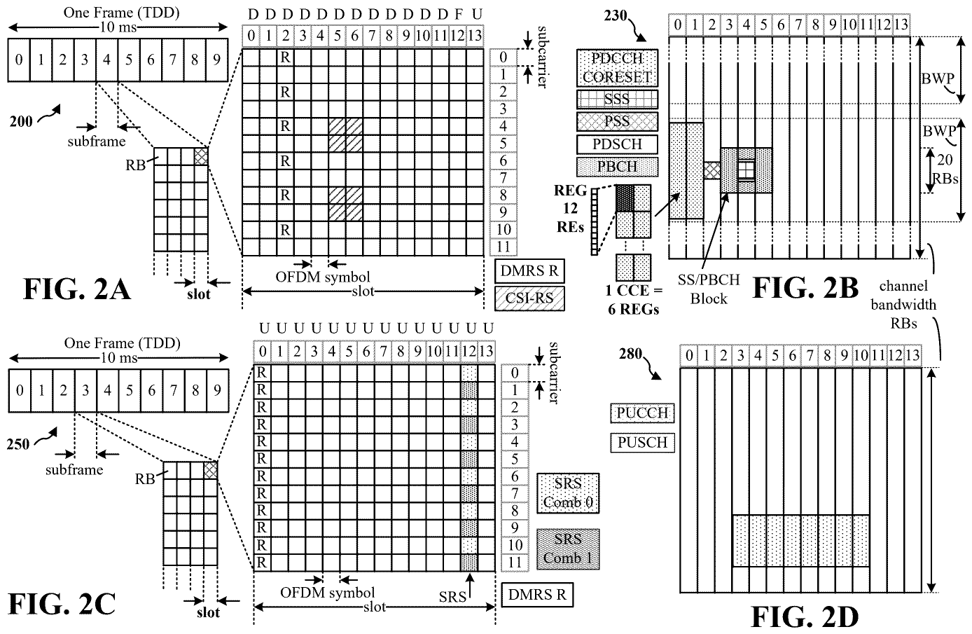

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

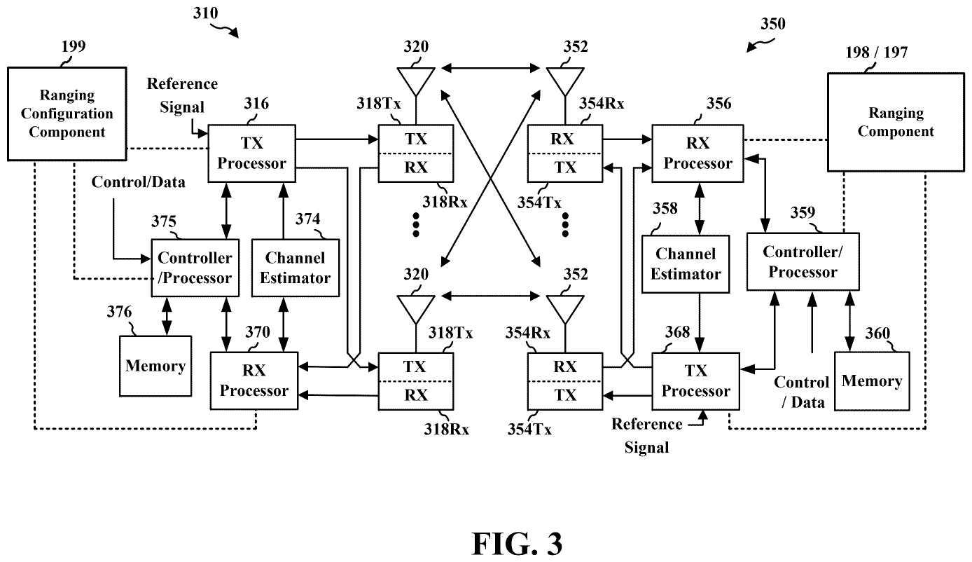

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the ranging component 198 of FIG. 1.

At least one of the TX processor 316, the RX processor 370, and the controller/processor 375 may be configured to perform aspects in connection with the ranging configuration component 199 of FIG. 1.

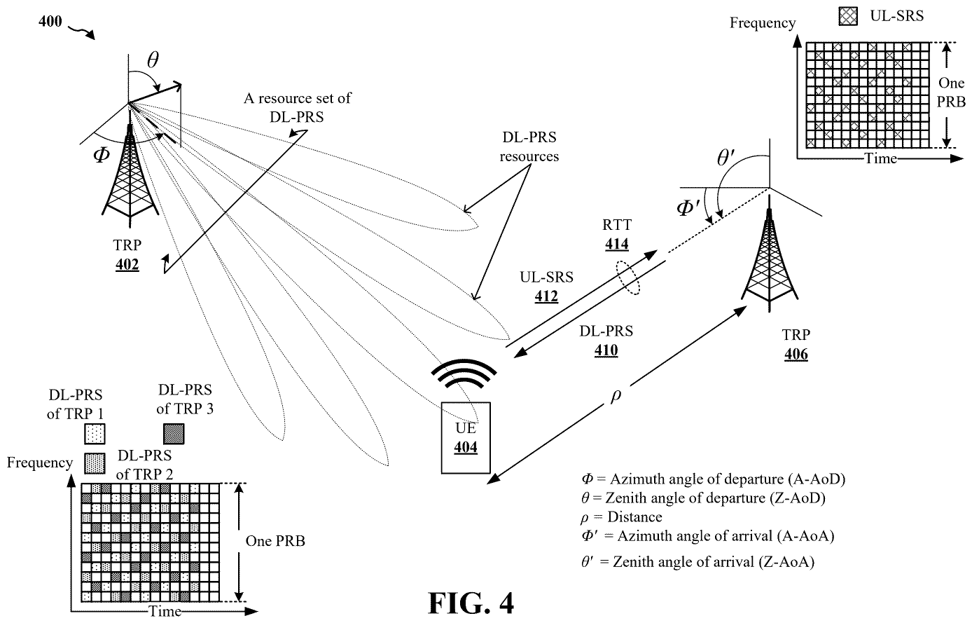

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle-of-arrival (A-AoA) and zenith angle-of-arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

Positioning based on measurement of time of arrival (ToA) and/or time difference of arrival (TDoA) may sometimes be referred to as ranged-based positioning, where the position of a wireless device may be determined based on measurements of distances between the wireless device and other wireless devices. For example, in range-based positioning, distances between wireless devices with a known location may be used for estimating the position of another wireless device without a known location based on a trilateration (or multilateration) process. In some examples, ranged-based positioning may be based on ultra-wideband (UWB) communications, where the UWB communications may include a radio signal with an instantaneous bandwidth of greater than 500 MHz or a fractional occupied bandwidth (Bf) greater than 0.2. For purposes of the present disclosure, a range-based positioning based on UWB may be referred to as UWB ranging, UWB positioning, an UWB ranging session, an UWB session, and/or an UWB ranging operation, etc. In one example, UWB ranging may refer to a device that is equipped with a UWB radio such as a smartphone, wristband, or smart key comes into range of another UWB device, and the devices start ranging. The ranging may be done by performing Time of Flight (ToF) measurements between the devices. The ToF may be calculated by measuring the roundtrip time of challenge/response packets. Depending on the type of the application (e.g. in case of asset tracking, device localization), either the mobile or the fixed UWB device may calculate the precise location of the device. In the case where the device is running an indoor navigation service, it may be specified to know its relative location to the fixed UWB anchors and calculate its position on the area map. As such, a UWB ranging session or a UWB session may refer to an instance, an occurrence, or a period of time where a device is configured to perform UWB ranging. In some examples, UWB may use very large channel bandwidth (500 MHz) with short pulses of about 2 nanoseconds each (e.g., this may help achieve centimeter accuracy). The UWB positioning process may happen in an instant, so the mobile device's movements can be tracked very accurately in real time. On the other hand, sidelink ranging session may refer to a ranging operation based on sidelink.

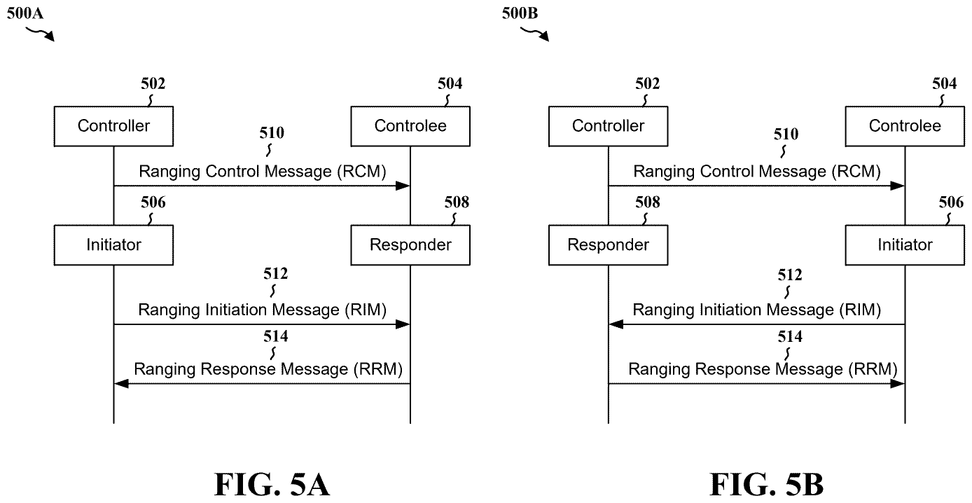

FIGS. 5A and 5B are diagrams 500A and 500B, respectively, illustrating example roles (e.g., logical/network entities) in an UWB ranging operation in accordance with various aspects of the present disclosure. In one example, an UWB ranging operation may be performed by a set of enhanced ranging devices (ERDEVs) that is capable of communicating with each other via UWB (e.g., transmitting/receiving UWB signals or waveforms) and also via non-UWB (which may be referred to as an out-of-band (OOB) communication, e.g., Bluetooth communication, Wi-Fi communication, etc.). In some examples, the ERDEVs may be a set of base stations, components of a base stations, a set of UEs, components of a UE, or a combination thereof.

Referring to the diagrams 500A and 500B, an UWB ranging operation may include multiple entities (or ERDEVs), such as a controller 502, a controlee 504, an initiator 506, and a responder 508. The controller 502 and the controlee 504 may be logical entities that are at a higher layer of a protocol stack, such as an application that is responsible for transmitting control messages (e.g., an application running on a device). On the other hand, the initiator 506 and the responder 508 may be operating at a physical (PHY) layer or a medium access control (MAC) layer, where signals may be exchanged between the initiator 506 and the responder 508 over the air based on UWB.

For example, as shown at 510, the controller 502 may be an ERDEV that controls an UWB ranging operation and defines the UWB ranging operation parameters for one or more controlees (e.g., the controlee 504) by sending a ranging control message (RCM) to the one or more controlees. The controlee 504 may be an ERDEV that utilizes the UWB ranging operation parameters received from the controller 502 in the RCM.

As shown at 512, the initiator 506 may be an ERDEV that follows the RCM and initiates a ranging message exchange by sending a first ranging message of the exchange (e.g., a ranging initiation message (RIM)) to one or more responders (e.g., the responder 508). Either a controller or a controlee may be an initiator. For example, as shown by the diagram 500A of FIG. 5A, the controller 502 may be the initiator 506, and as shown by the diagram 500B of FIG. 5B, the controlee 504 may be the initiator 506.

As shown at 514, the responder 508 may be an ERDEV that responds to the RIM received from the initiator 506. For example, in response to the RIM, the responder 508 may transmit a ranging response message (RRM) to the initiator 506. In one example, based on the RRM, the initiator 506 may determine a distance between the initiator 506 and the responder 508, such as based on the time of flight (ToF) of the RRM. For purposes of the present disclosure, a “ranging message” may refer to any types of messages that is transmitted during a ranging session, such as an UWB ranging session. The RRM may refer to a message that is transmitted in response to an RIM.

In some implementations, the transmission of the RCM at 510 may be based on OOB communications (e.g., non-UWB communications, such as based on Bluetooth communications, Wi-Fi communications, or other types of RF communications), whereas the transmission of the ranging messages (e.g., the RIM and/or the RRM, etc.) at 512 and 514 may be based on UWB (e.g., which may also be referred to as “in-band” communications). For purposes of the present disclosure, an UWB session may refer to a ranging session that is based on UWB. While aspects presented herein may use UWB as examples, aspects presented herein may also apply to sidelink or other types of ranging operations (e.g., ranging based on Wi-Fi, Bluetooth, 4G/5G/6G signals, etc.), which may also be considered as within the scope of the present disclosure.

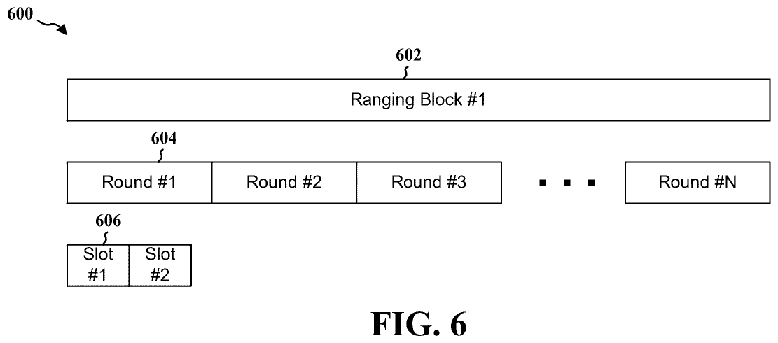

FIG. 6 is a diagram 600 illustrating an example time-scheduled or contention-free ranging in UWB in accordance with various aspects of the present disclosure. In one example, an UWB session between two devices may include consecutive ranging blocks 602. Each ranging block 602 may include multiple ranging rounds 604, and each ranging round 604 may in turn have several ranging slots 606. Within a ranging block 602, a responder (e.g., the responder 508) may transmit a message within a single ranging round 604. A ranging round index may be either statically configured by a controller (e.g., the controller 502) or selected based on a hopping pattern. The ranging slots 606 within a chosen ranging round 604 may be used sequentially to perform either single side-two way ranging (SS-TWR) or double side-two way ranging (DS-TWR). In some examples, multiple UWB sessions may be time-multiplexed (e.g., performed at different times) to prevent interference with one and another.

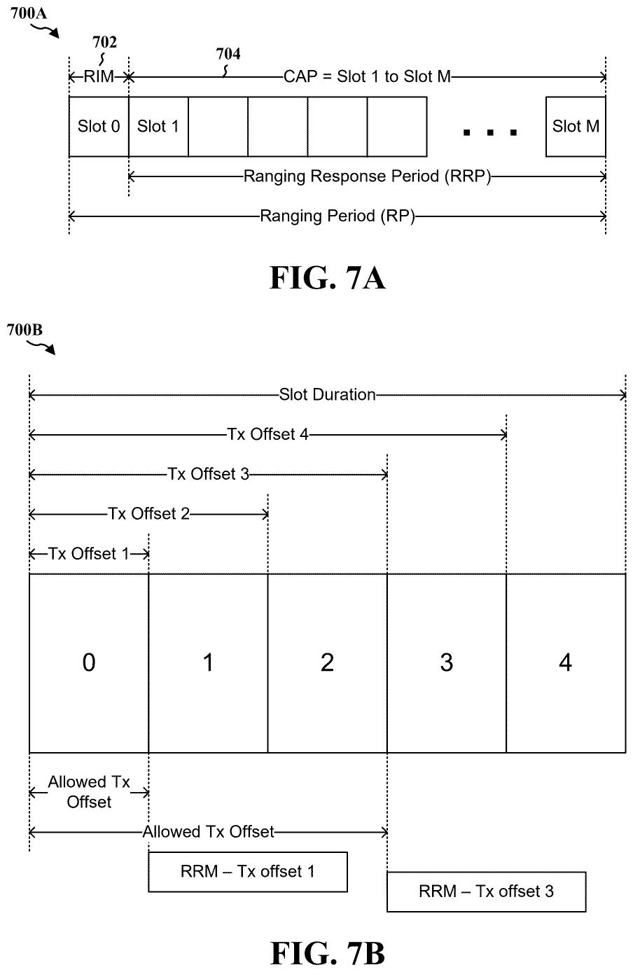

FIGS. 7A and 7B are diagrams 700A and 700B, respectively, illustrating an example contention-based ranging in UWB in accordance with various aspects of the present disclosure. In one example, a controller (e.g., the controller 502) may initiate a contention-based ranging when the controller does not know about the device(s) that are going to participate in an UWB session. In some implementations, the controller may be configured to assume the role of the initiator (e.g., the initiator 506), and the controlees (e.g., the controlee 504) may be configured to assume the role of the responders (e.g., the responder 508), such as shown by FIG. 5A.

As shown at 702 of FIG. 7A, to initiate a contention-based ranging, a controller (e.g., the controller 502) may advertise (e.g., transmitting/broadcasting) a contention-access period (CAP) via a ranging initiation message (RIM) to one or more devices. For purposes of the present disclosure, the term CAP may refer to a period of time during which a wireless device (e.g., a UE, a tag, a responder anchor) may send a message to or access a wireless medium using slotted carrier-sense multiple access with collision avoidance (CSMA-CA). On the other hand, the term CFP may refer to a period of time during which access to a wireless medium (e.g., an anchor) is free of contention.

As shown at 704, the CAP may include a portion of ranging slots within a ranging round (e.g., from slot 1 to slot M). A device that is configured to take part (e.g., participate) in the UWB session (and is not known by the controller) may randomly select a ranging slot from the portion of ranging slots (e.g., from slot 1 to slot M) and transmit a ranging response message (RRM) to the controller using the selected ranging slot, such as described in connection with FIG. 6. In some examples, as shown by the diagram 700B, within a ranging slot, a device that is taking part in the UWB session may also transmit an RRM after a random time offset. In other words, the device may not be specified to transmit the RRM from the beginning of the slot. In some examples, the allowable values for such a time offset may be contained within the control message from the controller.

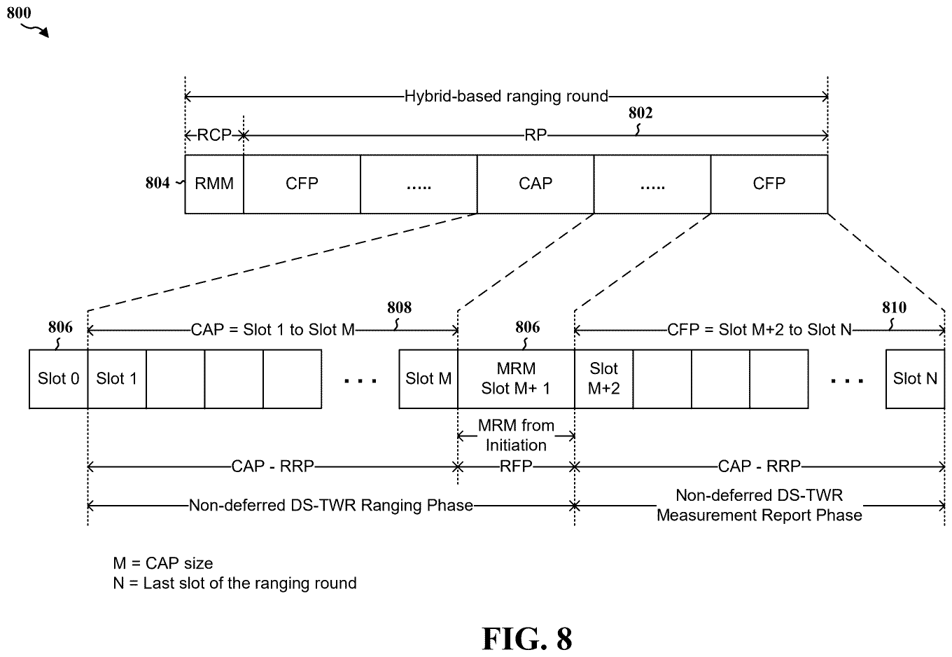

FIG. 8 is a diagram 800 illustrating an example hybrid-based ranging in UWB in accordance with various aspects of the present disclosure. In some examples, an UWB session may be configured with a hybrid-based ranging mode that allows a combination of time-scheduled (e.g., contention free) ranging and contention-based ranging in the same UWB Session.

For example, as shown at 802, a hybrid-based ranging round may include one or more CAPs and one or more contention free periods (CFPs). In certain scenarios, there may be a set of known controlees and a set of unknown controlees. In such scenarios, it may be beneficial for a controller to perform an UWB session with known controlees based on time-scheduled (e.g., contention free) mode, and perform the UWB session with unknown controlees based on the contention-based mode. For example, as shown at 808, a device that is not known to the controller that initiates the UWB session may randomly select a ranging slot in a CAP (e.g., from slot 1 to slot M) to transmit an RRM, such as described in connection with FIGS. 7A and 7B. On the other hand, as shown at 810, a device that is known to the controller may randomly select a ranging slot or use a specified/configured slot in a CFP (e.g., from slot M+2 to slot N) to transmit an RRM. As shown at 804, the first slot of the hybrid-based ranging round may be reserved for a control message that determines or indicates the start/end of each of the phases (e.g., a CFP phase or a CAP phase, etc.). As shown at 806, the first slot of each of the CAP and CFP phases may be reserved for control messages that determine the scheduling of the slots within the respective phase. In some examples, the last slot of each of the CAP and CFP phases may be reserved for a final message.

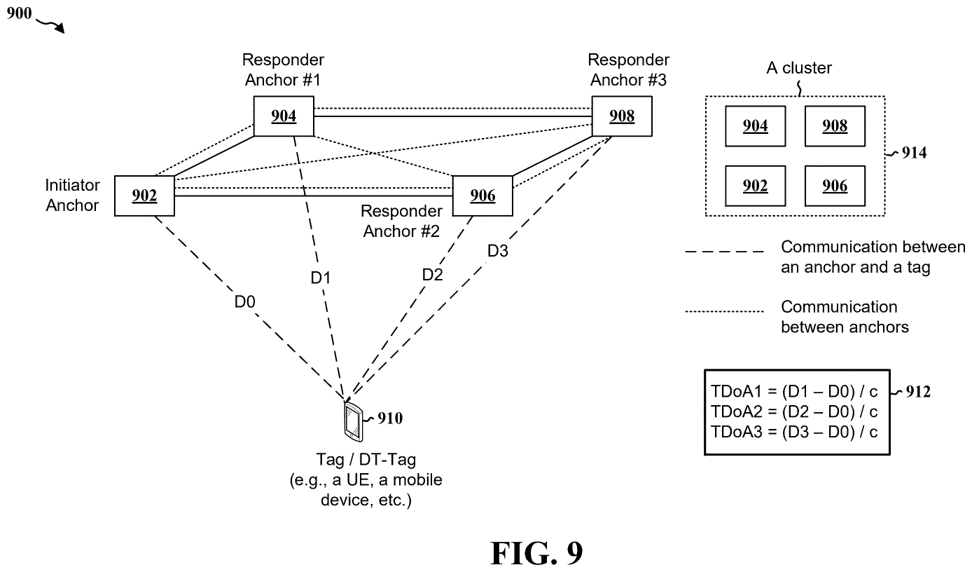

FIG. 9 is a diagram 900 illustrating an example UWB ranging based on downlink-time difference of arrival (DL-TDoA) in accordance with various aspects of the present disclosure. In one example, a DL-TDoA message (DTM) transmitted from a transmitting device (e.g., a fine ranging (FiRa) device, which may be an initiator or a responder) may be used by one or more receiving devices for performing localization or positioning. In some examples, this transmitting device may also be referred to as an anchor (e.g., an initiator anchor may be referred to as an initiator anchor, and a responder may be referred to as a responder anchor, etc.), and a receiving device may also be referred to as a tag, a DL-TDoA tag (DT-tag), a mobile device, and/or a UE. In general, an UWB ranging operation (e.g., an UWB session) may include one initiator anchor and multiple responder anchors, where a tag may listen and receive ranging messages (e.g., DTMs) transmitted from the initiator anchor and the responder anchors to determine its location based on the TDoA of ranging messages received.

For example, as shown by the diagram 900, an UWB ranging operation may include an initiator anchor 902, a first responder anchor 904, a second responder anchor 906, and a third responder anchor 908 (collectively as “DL-TDoA anchors”) that are configured to transmit/broadcast DTMs. A tag 910 may receive DTMs transmitted by these DL-TDoA anchors, and measure the reception times of every DTM that the tag 910 receives. Then, the tag 910 may utilize the reception timestamp along with obtained coordinates of DL-TDoA anchors to estimate its position. For example, as shown at 912, the tag 910 may calculate the TDoA for DTMs received between the initiator anchor 902 and other responder anchors 904, 906, and 908. Then, the tag 910 may estimate its position based on a trilateration (or multilateration) process. In some examples, the DTMs may also be used by anchors for performing synchronization between them. While DTMs may be exchanged between anchors, a tag may be configured to passively listen and receive DTMs (e.g., without transmitting messages to the anchors).

In one example, as shown at 914, a cluster or a cluster of anchors may refer to a set of anchors (e.g., a set of DL-TDoA anchors (DT-anchors)) that exchange DTMs with each other to provide a localization service to the tags (e.g., to the tag 910, to a set of DT-tags, etc.). A cluster may include one initiator anchor and one or more responder anchors. For example, the initiator anchor 902, the first responder anchor 904, the second responder anchor 906, and the third responder anchor 908 may be a cluster or part of a cluster. In some implementations, the DTM messages may also used for synchronization between the anchors. A final DTM message may be configured to be optional. Note that just the anchors (e.g., DT-anchors) may be configured to exchange messages, and the tags (e.g., DT-tags) may be configured to passively listen and receive packets.

An uplink (UL) TDoA-tag (UT-tag) may refer to a device (e.g., a FiRa device) that is configured to transmit blink UL-TDoA messages (UTMs) in order to be located by an UL-TDoA (UT)-anchor infrastructure. An UT-synchronization anchor may be configured to periodically send synchronization UTMs to enable in-band wireless clock synchronization. In the case of UL-TDoA, an initiator anchor is typically an UT-synchronization anchor while the responder anchors are regular UT anchors.

To create or establish a cluster, an anchor (e.g., a Bluetooth advertiser) may broadcast configuration messages (e.g., OOB configuration messages, RCMs, etc.) associated with UWB ranging to other anchors within a coverage area. For example, the initiator anchor 902 may create a cluster by broadcasting configuration messages to the first responder anchor 904, the second responder anchor 906, and the third responder anchor 908 based on OOB communications (e.g., non-UWB communications, Bluetooth communications, etc.). After receiving the configuration messages, the first responder anchor 904, the second responder anchor 906, and the third responder anchor 908 may apply UWB ranging related parameters in the configuration messages and join the cluster created by the initiator anchor 902. Then, the cluster may provide UWB ranging for one or more tags, such as the tag 910.

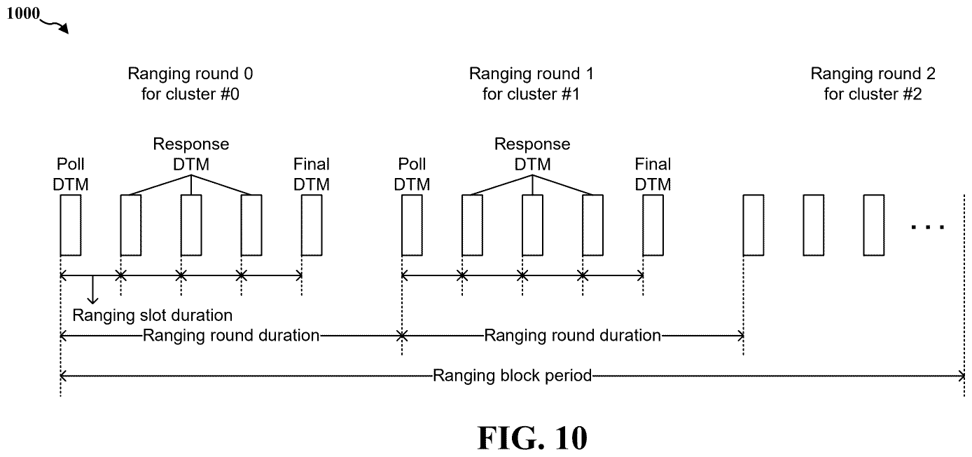

In some examples, as shown by a diagram 1000 of FIG. 10, when there is a plurality of clusters (e.g., clusters 0, 1, 2 . . . ), different clusters may be configured to perform UWB ranging in different time periods (e.g., ranging rounds) to avoid interference between clusters. For example, a first cluster (e.g., cluster #0) may be configured to perform an UWB ranging operation on a first ranging round, and a second cluster (e.g., cluster #1) may be configured to perform an UWB ranging operation on a second ranging round that does overlap with the first ranging round in time.

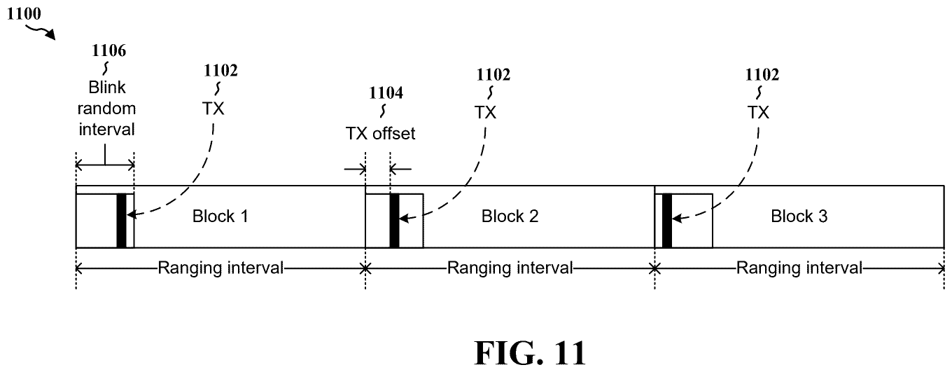

FIG. 11 is a diagram 1100 illustrating an example transmission of blink messages in accordance with various aspects of the present disclosure. As discussed in connection with FIG. 9, an UL-TDoA tag or UT-tag may refer to a wireless device (e.g., a FiRa device) that is capable of transmitting blink messages in order to be located by an anchor infrastructure. A UL-TDoA anchor or UT-anchor may refer to a wireless device (e.g., a FiRa device) that is capable of listening for blink messages from tags (e.g., UT-tags) or synchronization messages from other anchors (e.g., other UT-anchors). A time interval between two consecutive blink messages from a given UT-tag may define the TDoA position update rate at which the UT-tag may be located. As shown at 1102, to reduce the likelihood of collisions, UT-tags may be configured to randomly select a slot (or a “TX offset” as shown at 1104) within a blink random interval (e.g., as shown at 1106) to transmit a blink message.

Unlike cellular networks (e.g., the 4G LTE and/or 5G NR discussed in connection with FIG. 1) where the base stations may be tightly synchronized through the Global Positioning System (GPS), atomic clocks, and/or cable-based synchronization, UWB anchors are typically configured to rely on over-the-air (OTA) wireless time synchronization. However, wireless time synchronization is likely associated with error(s) that may degrade the position estimation accuracy, particularly in the case of UWB which seeks to achieve a centimeter (cm)-level accuracy. As an illustration, consider two anchors A and B. Let anchor A be a synchronization anchor which provides a time reference for anchor B to use and synchronize itself with. After anchor B receives, from anchor A, a ranging packet containing a time reference t_{A} (e.g., a timestamp indicating when the ranging packet is sent from anchor A), anchor B may establish its own reference time (t_{B}) as:

$${t}_{B} = {t}_{A} + {t}_{prop} + θ {t}_{prop} = \frac{{d}_{A B}}{c}$$

where tₚᵣₒₚ is the propagation delay and θ is an offset that corrects for clock offset and clock drift over time. Given the locations of anchor A and anchor B, the propagation delay may be obtained by the ratio of the distance between anchor A and anchor B (d_{AB}) to the speed of light c. However, the anchor locations are typically not known perfectly and are also associated with an error, which in turn may translate to an erroneous value for d_{AB}.

In addition, the value of θ is typically estimated using round trip time (RTT) (or range) measurements, such as via double-sided two-way ranging (DS-TWR) as described in connection with FIGS. 5A, 5B, and 6. However, in some scenarios, the value for θ may not be known/obtained perfectly since this may rely on a high-quality/precision RTT values, which may be inherently erroneous due to channel effects and/or group delay calibration errors, etc. Hence, the error in the time reference considered by anchor B may be expressed as:

$$Δ {t}_{B} = Δ {t}_{prop} + Δ θ$$

where Δtₚᵣₒₚ is a function of the anchor location accuracy, and Δθ is a function of the ranging accuracy between the anchors.

Aspects presented herein may improve/enhance the overall performance of ranging, such as UWB ranging. Aspects presented herein may enable one or more anchors to calculate and broadcast (e.g., in the case of DL-TDOA) an uncertainty value (and/or a confidence metric) associated with the synchronization accuracy, thereby enabling the tags to implement positioning algorithms that are capable of considering or taking advantage of these uncertainty values and/or confidence metrics, and also perform more informed anchor-selection strategies. Aspects presented herein may also enable synchronization anchors (i.e., anchors that are configured/selected to provide reference times) to be adaptively updated. In addition, aspects presented herein may enable the impact of the time reference considered by an anchor (e.g., Δt_{B} discussed above) to be reduced, which in turn leading to a higher position estimation accuracy (e.g., enabling RTT filtering over time, joint optimization of synchronization error and anchor node locations, etc.). Aspects presented herein may apply to various types of ranging technologies and are not limited to UWB ranging (e.g., may also be applicable to Wi-Fi ranging, Bluetooth ranging, network-based ranging, sidelink ranging, etc.).

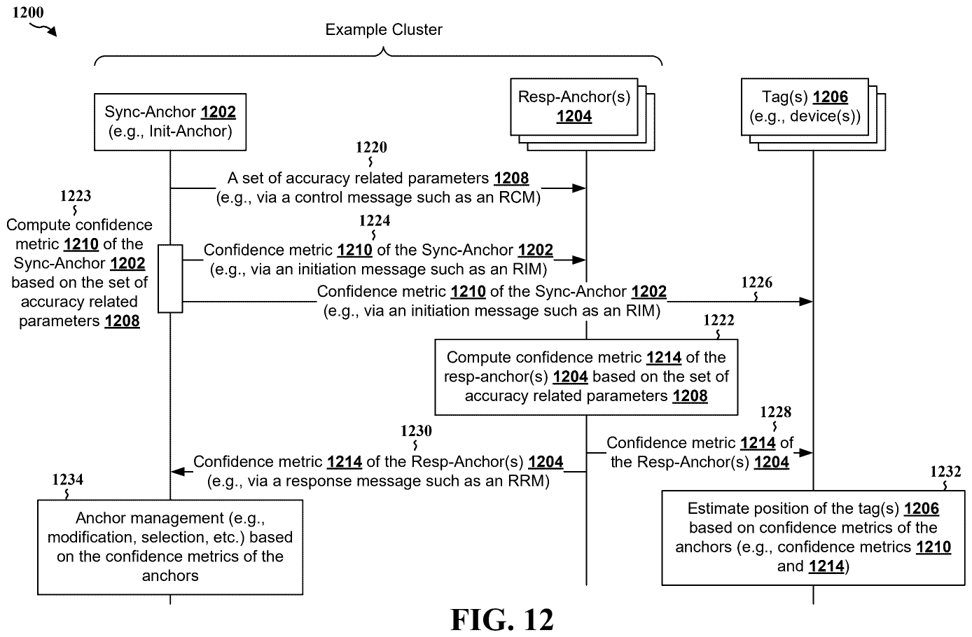

FIG. 12 is a communication flow 1200 illustrating an example of anchors providing their uncertainties and/or confidence metrics related to time synchronization based on a synchronization accuracy to improve ranging performance in accordance with various aspects of the present disclosure. The numberings associated with the communication flow 1200 do not specify a particular temporal order and are merely used as references for the communication flow 1200.

In one aspect of the present disclosure, a synchronization anchor 1202 (e.g., an initiator anchor, a first wireless device, a first network entity, the initiator 506, etc.) may be configured to provide a set of accuracy related parameters 1208 to a set of responder anchors. For ease of illustration, the set of responder anchors may collectively be referred to as a responder anchor 1204 (e.g., a second wireless device, a second network entity, the responder 508, etc.).

For example, at 1220, the synchronization anchor 1202 may provide, to the responder anchor 1204, a set of accuracy related parameters 1208 (e.g., configuration information) that enables the responder anchor 1204 to compute a confidence metric based on the set of accuracy related parameters 1208 (e.g., which may include an expected synchronization accuracy). Depending on implementations, the set of accuracy related parameters 1208 may include one or more of the followings:
(1) Anchor node location accuracy: by error propagation, a standard deviation in the anchor node locations may translate to a higher deviation in the distance between the anchors, which in turn may imply a higher deviation for the term Δtₚᵣₒₚ. Anchors may be configured to apply/use statistical method(s) to formulate a value for the standard deviation of Δtₚᵣₒₚ.
(2) Ranging accuracy between anchors: some ranging messages may include a field or an information element (IE) for “ranging figure-of-merit (FoM),” which may be used for characterizing the quality of a ranging estimate between two anchors/devices (e.g., a value between 0 and 1). The ranging FOM may in turn be used to gauge the accuracy of θ, i.e. Δθ may be found as a function of the ranging FoM.
(3) Clock stability: in addition to the anchor node location accuracy and/or the ranging accuracy between anchors, the synchronization anchor 1202 may include its clock stability value (e.g., in parts per million (ppm)), which in turn may be used by the responder anchor 1204 to compute Δθ.
(4) Hardware calibration errors: the synchronization anchor 1202 may include a hardware calibration accuracy (e.g., in nanosecond (ns)) that indicates to what level its hardware has been calibrated. Additionally, the responder anchor 1204 may be aware of its own hardware calibration accuracy.
(5) Formulation options: to enable the responder anchor 1204 to compute the confidence metric based on the set of accuracy related parameters 1208, the synchronization anchor 1202 may provide the responder anchor 1204 with a list of formulation options for computing the confidence metric.

As shown at 1222, based on the set of accuracy related parameters 1208, the responder anchor 1204 may compute a confidence metric 1214 for its synchronization accuracy. Depending on implementations, the confidence metric 1214 may be the standard deviation of the error in the synchronization time, which in turn may be a function of the above standard deviation values.

As an illustration, assuming the ranging is based on UWB (e.g., UWB ranging), at 1220, the synchronization anchor 1202 (e.g., an initiator anchor) may include in its RCM (as discussed in connection with FIGS. 5A and 5B, and/or specified by UWB configuration parameters of the UWB MAC layer specifications), the following data fields: (a) anchor node accuracy: a standard deviation value for each of the [x, y, z] or [latitude, longitude, altitude] coordinates, where the value may be expressed in centimeters and/or as a bitmap; (b) clock stability value (e.g., in ppm); (c) hardware calibration accuracy (e.g., in ns); and (d) a set of formulation options: to enable other anchors to compute the confidence metric. Multiple formulation options may be specified for the anchors. For example, one formulation (e.g., a first formulation) may indicate the responder anchor 1204 (or a receiving anchor) to use the clock stability value and the ranging FoM alone (e.g., to use just the clock stability and the ranging FoM to compute/estimate the confidence metric). Another formulation (e.g., a second formulation) may indicate the responder anchor 1204 to use the anchor node location and hardware calibration accuracy as well. In another example, a formulation option may also indicate which specific formulation or mathematical method to use for computing standard deviation values. For instance, another formulation (e.g., a third formulation) may provide the following formulation for calculating the standard deviation value of Δtₚᵣₒₚ as a function of the anchor node location uncertainties:

$${σ}_{Δ {t}_{prop}} = \sqrt{\begin{matrix}\frac{{( {x}_{2} - {x}_{1} )}^{2}}{{d}^{2}} \cdot ( {σ}_{{x}_{1}}^{2} + {σ}_{{x}_{2}}^{2} ) + \frac{{( {y}_{2} - {y}_{1} )}^{2}}{{d}^{2}} \cdot \\ ( {σ}_{{y}_{1}}^{2} + {σ}_{{y}_{2}}^{2} ) + \frac{{( {z}_{2} - {z}_{1} )}^{2}}{{d}^{2}} \cdot ( {σ}_{{z}_{1}}^{2} + {σ}_{{z}_{2}}^{2} )\end{matrix}}$$

As shown at 1223, the synchronization anchor 1202 may also compute a confidence metric 1210 of the synchronization anchor 1202 based on the set of accuracy related parameters 1208, such that there is a consistency in the confidence metrics provided by the anchors. Then, at the end of a ranging round (e.g., as discussed in connection with FIGS. 6 and 8, a plurality of anchors (e.g., the synchronization anchor 1202 and the responder anchor 1204) may compute a confidence metric for themselves.

After computing the confidence metric, the anchors may transmit/broadcast their computed confidence metrics (e.g., to other anchors and/or tags). For example, as shown at 1224 and 1226, after the synchronization anchor 1202 computed the confidence metric 1210 of the synchronization anchor 1202 (e.g., at 1222), the synchronization anchor 1202 may transmit/broadcast the confidence metric 1210, which may be received by the responder anchor as shown at 1224 and/or by a set of tags as shown at 1226. For ease of illustration, the set of tags may collectively be referred to as a tag 1206 (e.g., a user equipment (UE), a third wireless device, the tag 910, etc.). Similarly, as shown at 1228 and 1230, after the responder anchor 1204 computed the confidence metric 1214 of the responder anchor 1204 (e.g., at 1223), the responder anchor 1204 may transmit/broadcast the confidence metric 1214, which may be received by the tag 1206 as shown at 1228 and/or by the synchronization anchor 1202 shown at 1230. In a location server is configured to manage the anchors and/or to estimate the position of the tag 1206, the location server may also receive the confidence metrics from the anchors (not shown in the communication flow 1200).

At 1232, based on the confidence metrics received from a plurality of anchors, the tag 1206 may estimate its position (e.g., based on ranging messages received from the plurality of anchors as discussed in connection with FIG. 9) and take the confidence metrics of the plurality of anchors into consideration when estimating the position, such as applying offset(s) to its position estimation and/or ranging measurements, and/or selecting/using anchors with confidence metrics exceeding a threshold for the positioning. As an illustration, the tag 1206 may use the confidence metric 1210 from the synchronization anchor 1202 and the confidence metric 1214 from the responder anchor 1204 as part of their position estimation algorithm. A first example approach may be to select anchors with the highest confidence metric for positioning. A second example approach may be to apply a synchronization error correction term (e.g., to the TDoA measured by the tag 1206) for each anchor based on the corresponding confidence metric.

As discussed above, in some implementations, the ranging may be based on DL-TDOA and/or UL-TDOA. In one example, in the case of DL-TDOA, the anchors may be configured to include the confidence metric for the synchronization accuracy in their DL-TDoA message (DTM) messages. More specifically, the confidence metric may be included in the “OWR Message Type-dependent Payload” field of a one-way ranging (OWR) message (e.g., as specified by “Common part of the Payload IE Content Field for all OWR Messages” of UWB MAC layer specifications). In the case of UL-TDOA, the anchors may be configured to report the confidence metric to a location server (not shown in the communication flow 1200), where the position estimation of the tag 1206 (e.g., an UL-tag) may be performed by the location server. Similarly, the location server may also use the confidence metrics of anchors to select anchors with the highest confidence metric for positioning of the tag 1206, and/or to apply a synchronization error correction term (e.g., to the TDoA measured by the anchors) for each anchor based on the corresponding confidence metric.

In another aspect of the present disclosure, confidence metrics provided by anchors (e.g., by the synchronization anchor 1202 and/or the responder anchor 1204) may also be used by the anchor(s) and/or a location server for anchor managements (e.g., anchor selection, modifications, etc.) to improve the positioning accuracy. For example, as shown at 1234, based on the confidence metric 1214 from the responder anchor 1204 (assuming there is a plurality of responder anchors), the synchronization anchor 1202 may perform anchor managements such as selecting a number of anchors with highest/best confidence metrics for positioning of the tag 1206, selecting anchor(s) with confidence metrics exceeding a confidence threshold for positioning of the tag 1206, removing anchor(s) with confidence metrics below a confidence threshold from positioning of the tag 1206, switching the synchronization anchor (e.g., assigning a responder anchor to be the synchronization anchor instead of the synchronization anchor 1202 if the responder anchor has better capability/accuracy than the synchronization anchor 1202). Similarly, if a location server is involved, the location server may be configured to perform anchor management based on the confidence metrics provided by the anchors (not shown in the communication flow 1200).

In one aspect of the present disclosure, the confidence metrics provided by the anchors (e.g., the confidence metric 1210 from the synchronization anchor 1202 and/or the confidence metric 1214 from the responder anchor 1204) may be used (e.g., by one or more anchors or by a location server) for scheduling and/or synchronization anchor selection. For example, the scheduling may be improved for identifying a best (e.g., a most suitable) synchronization anchor amongst a set of anchors. The current/typical approach is simply selecting a given synchronization anchor, and to impose a shorter blink random interval for the synchronization anchor in comparison to the responder anchor(s) and tags. However, the current/typical approach does not enable anchor(s)/location server to adaptively shift the role of a synchronization anchor over time.

As an illustration, consider the following example methodology to adaptively change/modify the synchronization anchor. An initial synchronization anchor may be configured to schedule a ranging round, specifically dedicated to the anchor infrastructure (e.g., with no tags involved). Alternatively, the synchronization anchor may schedule a CFP for the anchors, while the CAP is scheduled for tags (e.g., as discussed in connection with FIG. 8). Then, multiple anchors (e.g., a plurality of UWB anchors) may be configured to iterate over multiple combinations with distinct synchronization anchors (e.g., various anchors taking the role of the synchronization anchor), and maintain a list of corresponding confidence metrics (a function of the standard deviation value of Δtₚᵣₒₚ). Depending on implementations, this process may specify each anchor in multiple anchors to assume the role of the synchronization anchor (or the initiator anchor) and exchange ranging messages. In some examples, a single round or a CFP within a round may be scheduled (e.g., by anchor(s)/location server) to enable the exchange of ranging messages with distinct anchors. The ranging messages may contain the confidence metric along with the corresponding synchronization anchor that was used during that iteration.

Based on the list of corresponding confidence metrics, the anchor with the highest confidence metric in synchronization accuracy may be selected as the synchronization anchor. In other words, an anchor with the best clock stability, highest ground truth accuracy, and/or best ranging accuracy with other anchors may be selected as the synchronization anchor. As discussion above, the selection of the synchronization anchor may be performed by the location server, or by the initial synchronization anchor. As such, aspects presented herein may enable the best synchronization anchor to be used in a real-time or dynamic manner.

In another aspect of the present disclosure, the confidence metrics provided by the anchors (e.g., the confidence metric 1210 from the synchronization anchor 1202 and/or the confidence metric 1214 from the responder anchor 1204) may be used (e.g., by one or more anchors or by a location server) for reducing synchronization error. For example, a lower value for the synchronization error may be achieved (or the standard deviation value of Δtₚᵣₒₚ) by maintaining a set of ranging measurements over time, and using the set of ranging measurements with the best ranging FoM for the position/range estimation. In addition, the estimated range/position (of the tag) may be used in place of anchor node locations to calculate the distance between the anchors and the resultant propagation delay (tₚᵣₒₚ).

As an illustration, consider the following example methodology. A set of anchors (e.g., a set of UWB anchors) may be configured to exchange ranging messages with one another and determine a ranging FoM. The set of anchors may be configured to perform multiple measurements repeatedly until a threshold number of measurements (e.g., 5 measurements, 10 measurements, etc.) above a specified ranging FoM threshold (e.g., assuming 0.8) is obtained (in other words, at least 5 or 10 measurements with ranging FoM exceeding 0.8 are obtained). Then, these high-quality measurements may be used for computing the term Δθ. Furthermore, if the anchor node locations are below a threshold accuracy (e.g., the error is higher than two meters as an example), then the high-quality measurements may be used to calculate tₚᵣₒₚ (instead of the anchor node locations). The above computations may be performed at a location server (which may specify/demand the anchors to report their measurements to the location server periodically) or by at least one of the anchors. Also, these operations may be configured to be performed periodically such that overall synchronization accuracy across a plurality of anchors is high, thereby improving the position estimation accuracy for tags.

Anchors, such as UWB anchors, may rely on over the air wireless time synchronization which may suffer from inaccuracies in propagation delays and clock offset/drift calculations. Aspects presented herein enables a synchronization anchor (SA or sync-anchor) to include in its RCM to other anchors, parameters, along with equations/methods that use the parameters to calculate a confidence metric for the anchor's synchronization accuracy. The anchors may then include this confidence metric for the synchronization accuracy in their DTM messages to tags/location servers. This information may then be used during position estimation of a tag to select anchors with the highest confidence metric for positioning or apply a synchronization error correction term to TDoA measurements.

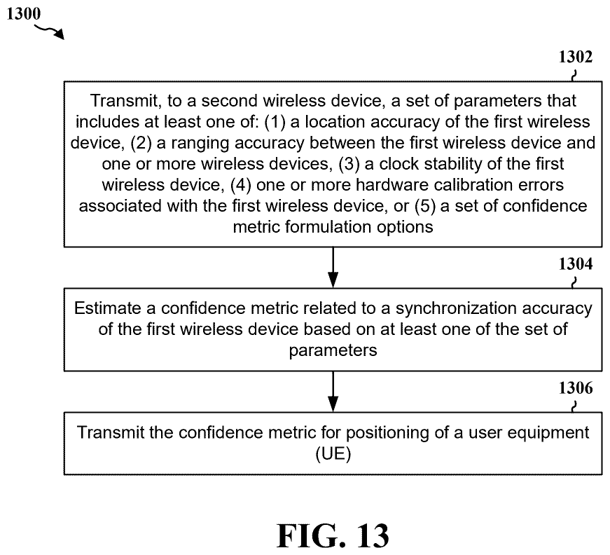

FIG. 13 is a flowchart 1300 of a method of wireless communication. The method may be performed by a first wireless device (e.g., the UE 104, 404; the controller 502; the controlee 504; the initiator 506; the initiator anchor 902; the synchronization anchor 1202; the apparatus 1404). The method may enable the first wireless device to provide, to at least a second wireless device, a set of parameters for calculating a confidence metric for synchronization accuracy, and also provide its confidence metric to the second wireless device and/or a user equipment (UE), thereby improving the positioning of the UE.

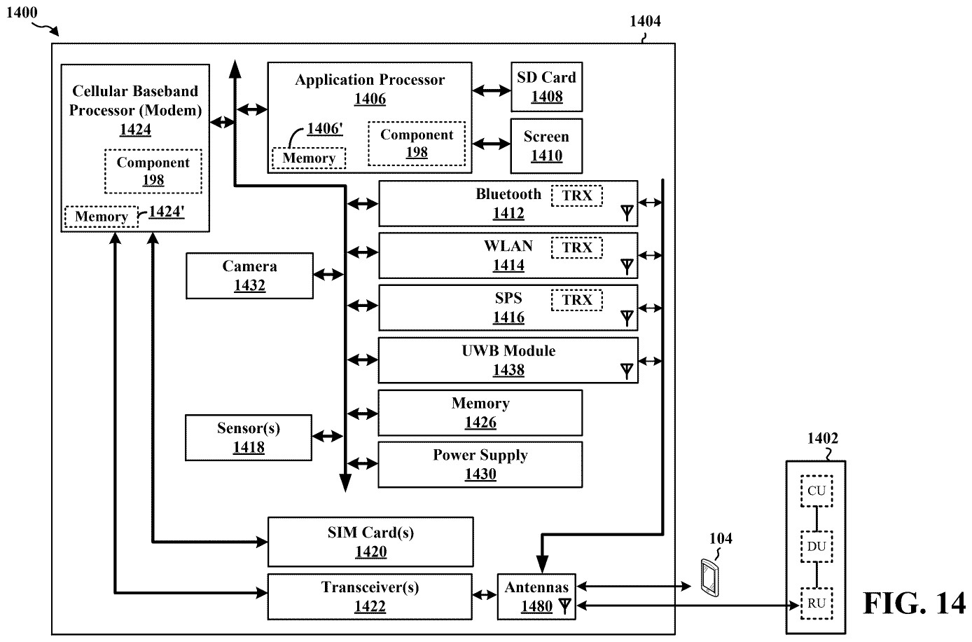

At 1302, the first wireless device may transmit, to a second wireless device, a set of parameters that includes at least one of: (1) a location accuracy of the first wireless device, (2) a ranging accuracy between the first wireless device and one or more wireless devices, (3) a clock stability of the first wireless device, (4) one or more hardware calibration errors associated with the first wireless device, or (5) a set of confidence metric formulation options, such as described in connection with FIG. 12. For example, at 1220, the synchronization anchor 1202 may provide, to the responder anchor 1204, a set of accuracy related parameters 1208 (e.g., configuration information) that enables the responder anchor 1204 to compute a confidence metric based on the set of accuracy related parameters 1208 (e.g., which may include an expected synchronization accuracy). Depending on implementations, the set of accuracy related parameters 1208 may include one or more of the followings: (1) Anchor node location accuracy, (2) Ranging accuracy between anchors, (3) Clock stability, (4) Hardware calibration errors, and/or (5) Formulation options. The transmission of the set of parameters may be performed by, e.g., the ranging component 198, the application processor 1406, the cellular baseband processor 1424, the UWB module 1438, and/or the transceiver(s) 1422 of the apparatus 1404 in FIG. 14.

At 1304, the first wireless device may estimate a confidence metric related to a synchronization accuracy of the first wireless device based on at least one of the set of parameters, such as described in connection with FIG. 12. For example, at 1223, the synchronization anchor 1202 may also compute a confidence metric 1210 of the synchronization anchor 1202 based on the set of accuracy related parameters 1208. The estimation of the confidence metric may be performed by, e.g., the ranging component 198, the application processor 1406, the cellular baseband processor 1424, the UWB module 1438, and/or the transceiver(s) 1422 of the apparatus 1404 in FIG. 14.

At 1306, the first wireless device may transmit the confidence metric for positioning of a UE, such as described in connection with FIG. 12. For example, after the synchronization anchor 1202 computed the confidence metric 1210 of the synchronization anchor 1202, the synchronization anchor 1202 may transmit/broadcast the confidence metric 1210, which may be received by the responder anchor as shown at 1224 and/or by a set of tags as shown at 1226. The transmission of the confidence metric may be performed by, e.g., the ranging component 198, the application processor 1406, the cellular baseband processor 1424, the UWB module 1438, and/or the transceiver(s) 1422 of the apparatus 1404 in FIG. 14.

In one example, the first wireless device may further receive, from the second wireless device based on the set of parameters, a second confidence metric related to a second synchronization accuracy of the second wireless device, and modify at least one wireless device for the positioning of the UE based on the second confidence metric.

In another example, to transmit the confidence metric, the first wireless device may be configured to transmit the confidence metric to a server, and the first wireless device may further receive, from the server based on the confidence metric, an indication to modify at least one wireless device for the positioning of the UE based on the confidence metric.

In another example, to transmit the confidence metric, the first wireless device may be configured to transmit the confidence metric to at least one of the second wireless device, a server, or the UE.

In another example, the first wireless device is an initiator anchor or a synchronization anchor, the second wireless device is a responder anchor, and the UE is a mobile device or a tag.

In another example, the first wireless device may further receive a plurality of confidence metrics from a plurality of wireless devices based on the set of parameters, and maintain a record of confidence metrics for the plurality of wireless devices.

In another example, the first wireless device may further exchange a set of ranging messages with the second wireless device until a threshold number of measurements is above a ranging figure of merit (FoM) threshold, where estimation of the confidence metric is further based on one or more measurements in the threshold number of measurements.

In another example, to transmit the set of parameters, the first wireless device may be configured to transmit the set of parameters via a ranging control message (RCM) or an out-of-band (OOB) message.

In another example, to transmit the confidence metric, the first wireless device may be configured to transmit the confidence metric via a downlink time different of arrival (TDoA) message (DTM).

In another example, the synchronization accuracy corresponds to a standard deviation of an error in a synchronization time.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include a cellular baseband processor 1424 (also referred to as a modem) coupled to one or more transceivers 1422 (e.g., cellular RF transceiver). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, a Ultrawideband (UWB) module 1438, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor 1424 communicates through the transceiver(s) 1422 via one or more antennas 1480 with the UE 104 and/or with an RU associated with a network entity 1402. The cellular baseband processor 1424 and the application processor 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described supra. The computer-readable medium/memory may also be used for storing data that is manipulated by the cellular baseband processor 1424/application processor 1406 when executing software. The cellular baseband processor 1424/application processor 1406 may be a component of the UE 350 and may include the memory 360 and/or at least one of the TX processor 368, the RX processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see UE 350 of FIG. 3) and include the additional modules of the apparatus 1404.

As discussed supra, the ranging component 198 may be configured to transmit, to a second wireless device, a set of parameters that includes at least one of: (1) a location accuracy of the first wireless device, (2) a ranging accuracy between the first wireless device and one or more wireless devices, (3) a clock stability of the first wireless device, (4) one or more hardware calibration errors associated with the first wireless device, or (5) a set of confidence metric formulation options. The ranging component 198 may also be configured to estimate a confidence metric related to a synchronization accuracy of the first wireless device based on at least one of the set of parameters. The ranging component 198 may also be configured to transmit the confidence metric for positioning of a UE. The ranging component 198 may be within the cellular baseband processor 1424, the application processor 1406, or both the cellular baseband processor 1424 and the application processor 1406. The ranging component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1404 may include a variety of components configured for various functions. In one configuration, the apparatus 1404, and in particular the cellular baseband processor 1424 and/or the application processor 1406, may include means for transmitting, to a second wireless device, a set of parameters that includes at least one of: (1) a location accuracy of the first wireless device, (2) a ranging accuracy between the first wireless device and one or more wireless devices, (3) a clock stability of the first wireless device, (4) one or more hardware calibration errors associated with the first wireless device, or (5) a set of confidence metric formulation options. The apparatus 1404 may further include means for estimating a confidence metric related to a synchronization accuracy of the first wireless device based on at least one of the set of parameters. The apparatus 1404 may further include means for transmitting the confidence metric for positioning of a UE.

In one configuration, the apparatus 1404 may further include means for receiving, from the second wireless device based on the set of parameters, a second confidence metric related to a second synchronization accuracy of the second wireless device, and means for modifying at least one wireless device for the positioning of the UE based on the second confidence metric.

In another configuration, the means for transmitting the confidence metric may include configuring the apparatus 1404 to transmit the confidence metric to a server, and the apparatus 1404 may further include means for receiving, from the server based on the confidence metric, an indication to modify at least one wireless device for the positioning of the UE based on the confidence metric.

In another configuration, the means for transmitting the confidence metric may include configuring the apparatus 1404 to transmit the confidence metric to at least one of the second wireless device, a server, or the UE.

In another configuration, the first wireless device is an initiator anchor or a synchronization anchor, the second wireless device is a responder anchor, and the UE is a mobile device or a tag.

In another configuration, the apparatus 1404 may further include means for receiving a plurality of confidence metrics from a plurality of wireless devices based on the set of parameters, and means for maintaining a record of confidence metrics for the plurality of wireless devices.

In another configuration, the apparatus 1404 may further include means for exchanging a set of ranging messages with the second wireless device until a threshold number of measurements is above a ranging figure of merit (FoM) threshold, where estimation of the confidence metric is further based on one or more measurements in the threshold number of measurements.

In another configuration, the means for transmitting the set of parameters may include configuring the apparatus 1404 to transmit the set of parameters via an RCM or an OOB message.

In another configuration, the means for transmitting the confidence metric may include configuring the apparatus 1404 to transmit the confidence metric via a DTM.

In another configuration, the synchronization accuracy corresponds to a standard deviation of an error in a synchronization time.

The means may be the ranging component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

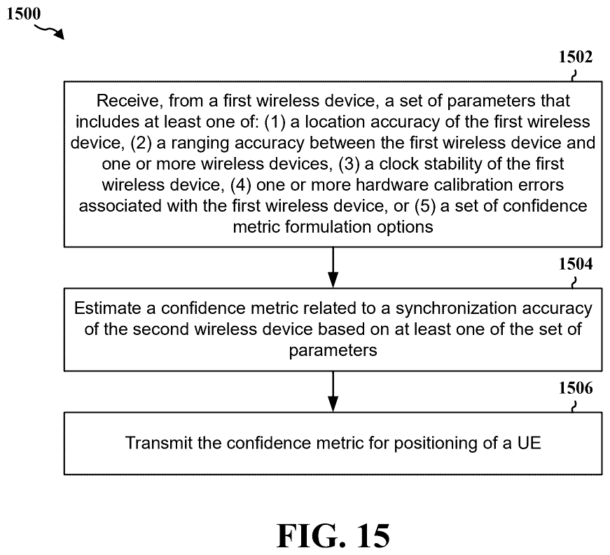

FIG. 15 is a flowchart 1500 of a method of wireless communication. The method may be performed by a second wireless device (e.g., the UE 104, 404; the controller 502; the controlee 504; the responder 508; the responder anchor 904, 906, 908, 1204; the apparatus 1604). The method may enable the second wireless device to receive, from a first wireless device, a set of parameters for calculating a confidence metric for synchronization accuracy. Then, the second wireless device may calculate a confidence metric based on the set of parameters, and provide the confidence metric to the first wireless device and/or a UE, thereby improving the positioning of the UE.

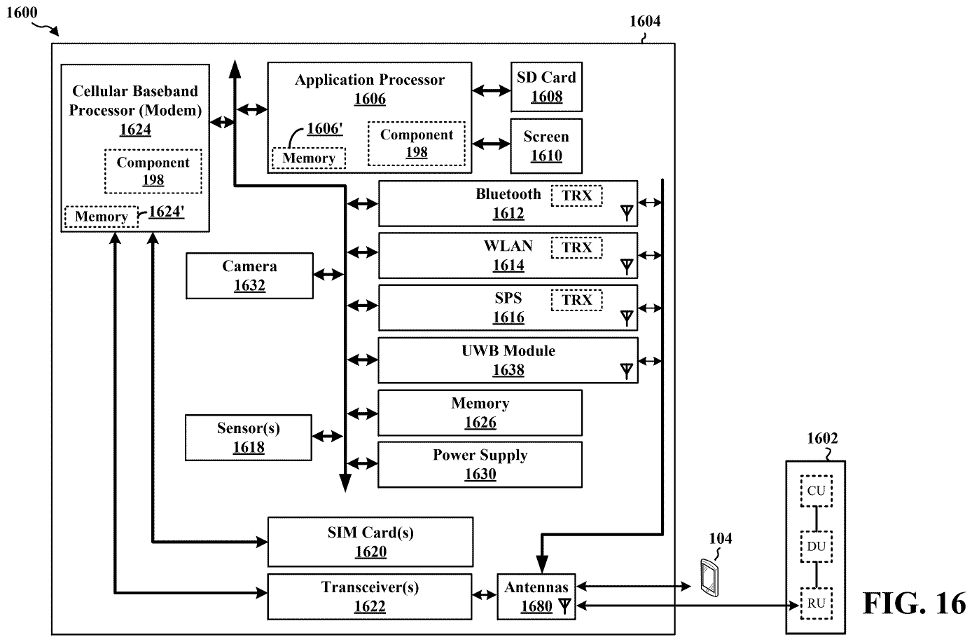

At 1502, the second wireless device may receive, from a first wireless device, a set of parameters that includes at least one of: (1) a location accuracy of the first wireless device, (2) a ranging accuracy between the first wireless device and one or more wireless devices, (3) a clock stability of the first wireless device, (4) one or more hardware calibration errors associated with the first wireless device, or (5) a set of confidence metric formulation options, such as described in connection with FIG. 12. For example, at 1220, the responder anchor 1204 may receive, from the synchronization anchor 1202, a set of accuracy related parameters 1208 (e.g., configuration information) that enables the responder anchor 1204 to compute a confidence metric based on the set of accuracy related parameters 1208 (e.g., which may include an expected synchronization accuracy). Depending on implementations, the set of accuracy related parameters 1208 may include one or more of the followings: (1) Anchor node location accuracy, (2) Ranging accuracy between anchors, (3) Clock stability, (4) Hardware calibration errors, and/or (5) Formulation options. The reception of the set of parameters may be performed by, e.g., the ranging component 198, the application processor 1606, the cellular baseband processor 1624, the UWB module 1638, and/or the transceiver(s) 1622 of the apparatus 1604 in FIG. 16.

At 1504, the second wireless device may estimate a confidence metric related to a synchronization accuracy of the second wireless device based on at least one of the set of parameters, such as described in connection with FIG. 12. For example, at 1222, based on the set of accuracy related parameters 1208, the responder anchor 1204 may compute a confidence metric 1214 for its synchronization accuracy. The estimation of the confidence metric may be performed by, e.g., the ranging component 198, the application processor 1606, the cellular baseband processor 1624, the UWB module 1638, and/or the transceiver(s) 1622 of the apparatus 1604 in FIG. 16.

At 1506, the second wireless device may transmit the confidence metric for positioning of a UE, such as described in connection with FIG. 12. For example, after the responder anchor 1204 computed the confidence metric 1214 of the responder anchor 1204, the responder anchor 1204 may transmit/broadcast the confidence metric 1214, which may be received by the tag 1206 as shown at 1228 and/or by the synchronization anchor 1202 shown at 1230. The transmission of the confidence metric may be performed by, e.g., the ranging component 198, the application processor 1606, the cellular baseband processor 1624, the UWB module 1638, and/or the transceiver(s) 1622 of the apparatus 1604 in FIG. 16.

In one example, the second wireless device may further receive, from the first wireless device based on the set of parameters, a second confidence metric related to a second synchronization accuracy of the first wireless device, and modify at least one wireless device for the positioning of the UE based on the second confidence metric.

In another example, to transmit the confidence metric, the second wireless device may be configured to transmit the confidence metric to a server, and the second wireless device may further receive, from the server based on the confidence metric, an indication to modify at least one wireless device for the positioning of the UE based on the confidence metric.

In another example, to transmit the confidence metric, the second wireless device may be configured to transmit the confidence metric to at least one of the first wireless device, a server, or the UE.

In another example, the second wireless device is a responder anchor, the first wireless device is an initiator anchor or a synchronization anchor, and the UE is a mobile device or a tag.

In another example, the second wireless device may further receive a plurality of confidence metrics from a plurality of wireless devices based on the set of parameters, and maintain a record of confidence metrics for the plurality of wireless devices.

In another example, the second wireless device may further exchange a set of ranging messages with the first wireless device until a threshold number of measurements is above a ranging FoM threshold, where estimation of the confidence metric is further based on one or more measurements in the threshold number of measurements.

In another example, to receive the set of parameters, the second wireless device may be configured to receive the set of parameters via an RCM or an OOB message.

In another example, to transmit the confidence metric, the second wireless device may be configured to transmit the confidence metric via a DTM.

In another example, the synchronization accuracy corresponds to a standard deviation of an error in a synchronization time.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, a Ultrawideband (UWB) module 1638, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see UE 350 of FIG. 3) and include the additional modules of the apparatus 1604.

As discussed supra, the ranging component 198 may be configured to receive, from a first wireless device, a set of parameters that includes at least one of: (1) a location accuracy of the first wireless device, (2) a ranging accuracy between the first wireless device and one or more wireless devices, (3) a clock stability of the first wireless device, (4) one or more hardware calibration errors associated with the first wireless device, or (5) a set of confidence metric formulation options. The ranging component 198 may also be configured to estimate a confidence metric related to a synchronization accuracy of the second wireless device based on at least one of the set of parameters. The ranging component 198 may also be configured to transmit the confidence metric for positioning of a UE. The ranging component 198 may be within the cellular baseband processor 1624, the application processor 1606, or both the cellular baseband processor 1624 and the application processor 1606. The ranging component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, may include means for receiving, from a first wireless device, a set of parameters that includes at least one of: (1) a location accuracy of the first wireless device, (2) a ranging accuracy between the first wireless device and one or more wireless devices, (3) a clock stability of the first wireless device, (4) one or more hardware calibration errors associated with the first wireless device, or (5) a set of confidence metric formulation options. The apparatus 1604 may further include means for estimating a confidence metric related to a synchronization accuracy of the second wireless device based on at least one of the set of parameters. The apparatus 1604 may further include means for transmitting the confidence metric for positioning of a UE.

In one configuration, the apparatus 1604 may further include means for receiving, from the first wireless device based on the set of parameters, a second confidence metric related to a second synchronization accuracy of the first wireless device, and means for modifying at least one wireless device for the positioning of the UE based on the second confidence metric.

In another configuration, the means for transmitting the confidence metric may include configuring the apparatus 1604 to transmit the confidence metric to a server, and the apparatus 1604 may further include means for receiving, from the server based on the confidence metric, an indication to modify at least one wireless device for the positioning of the UE based on the confidence metric.

In another configuration, the means for transmitting the confidence metric may include configuring the apparatus 1604 to transmit the confidence metric to at least one of the first wireless device, a server, or the UE.

In another configuration, the second wireless device is a responder anchor, the first wireless device is an initiator anchor or a synchronization anchor, and the UE is a mobile device or a tag.

In another configuration, the apparatus 1604 may further include means for receiving a plurality of confidence metrics from a plurality of wireless devices based on the set of parameters, and means for maintaining a record of confidence metrics for the plurality of wireless devices.

In another configuration, the apparatus 1604 may further include means for exchanging a set of ranging messages with the first wireless device until a threshold number of measurements is above a ranging FoM threshold, where estimation of the confidence metric is further based on one or more measurements in the threshold number of measurements.

In another configuration, the means for receiving the set of parameters may include configuring the apparatus 1604 to receive the set of parameters via an RCM or an OOB message.

In another configuration, the means for transmitting the confidence metric may include configuring the apparatus 1604 to transmit the confidence metric via a DTM.

In another configuration, the synchronization accuracy corresponds to a standard deviation of an error in a synchronization time.

The means may be the ranging component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

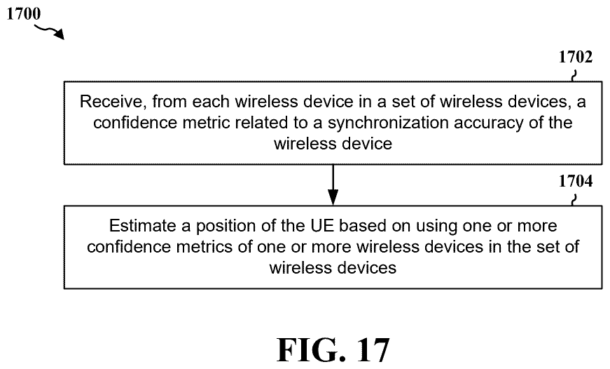

FIG. 17 is a flowchart 1700 of a method of wireless communication. The method may be performed by a user equipment (UE) (e.g., the UE 104, 404; the tag 910, 1206; the apparatus 1804). The method may enable the UE to take confidence metrics of anchors into consideration when estimating its position based on ranging, thereby improving the accuracy of the ranging.

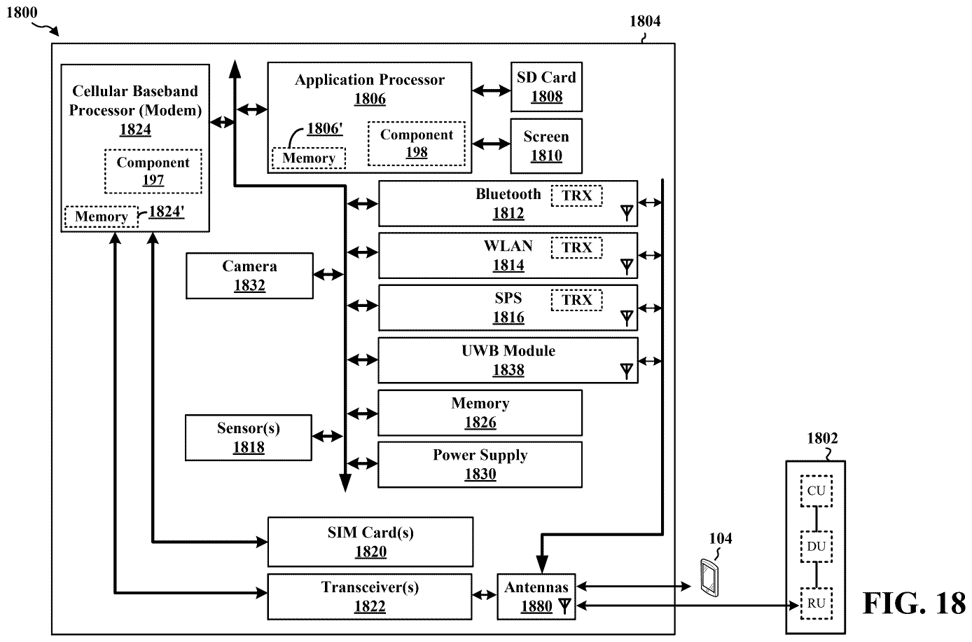

At 1702, the UE may receive, from each wireless device in a set of wireless devices, a confidence metric related to a synchronization accuracy of the wireless device, such as described in connection with FIG. 12. For example, at 1226 and 1228, the tag 1206 may receive the confidence metric 1210 from the synchronization anchor 1202 and/or the confidence metric 1214 from the responder anchor 1204. The reception of the confidence metric may be performed by, e.g., the ranging component 197, the application processor 1806, the cellular baseband processor 1824, the UWB module 1838, and/or the transceiver(s) 1822 of the apparatus 1804 in FIG. 18.

At 1704, the UE may estimate a position of the UE based on using one or more confidence metrics of one or more wireless devices in the set of wireless devices, such as described in connection with FIG. 12. For example, at 1232, based on the confidence metrics received from a plurality of anchors, the tag 1206 may estimate its position (e.g., based on ranging messages received from the plurality of anchors as discussed in connection with FIG. 9) and take the confidence metrics of the plurality of anchors into consideration when estimating the position, such as applying offset(s) to its position estimation and/or ranging measurements. The estimation of the position may be performed by, e.g., the ranging component 197, the application processor 1806, the cellular baseband processor 1824, the UWB module 1838, and/or the transceiver(s) 1822 of the apparatus 1804 in FIG. 18.

In one example, to estimate the position of the UE based on using the one or more confidence metrics of the one or more wireless devices in the set of wireless devices, the UE may be configured to select the one or more wireless devices in the set of wireless devices for estimating the position of the UE based on their corresponding confidence metrics, and perform positioning of the UE based on using the selected one or more wireless devices.

In another example, to estimate the position of the UE based on using the one or more confidence metrics of the one or more wireless devices in the set of wireless devices, the UE may be configured to apply a synchronization error correction term for each measurement between the UE and each of the one or more wireless devices based on a corresponding confidence metrics of the each of the one or more wireless devices, and estimate the position of the UE based on a set of measurements between the UE and the one or more wireless devices.

In another example, the set of wireless devices includes at least one initiator anchor or synchronization anchor, and the UE is a mobile device or a tag.

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include a cellular baseband processor 1824 (also referred to as a modem) coupled to one or more transceivers 1822 (e.g., cellular RF transceiver). The cellular baseband processor 1824 may include on-chip memory 1824′. In some aspects, the apparatus 1804 may further include one or more subscriber identity modules (SIM) cards 1820 and an application processor 1806 coupled to a secure digital (SD) card 1808 and a screen 1810. The application processor 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, a Ultrawideband (UWB) module 1838, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor 1824 communicates through the transceiver(s) 1822 via one or more antennas 1880 with the UE 104 and/or with an RU associated with a network entity 1802. The cellular baseband processor 1824 and the application processor 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described supra. The computer-readable medium/memory may also be used for storing data that is manipulated by the cellular baseband processor 1824/application processor 1806 when executing software. The cellular baseband processor 1824/application processor 1806 may be a component of the UE 350 and may include the memory 360 and/or at least one of the TX processor 368, the RX processor 356, and the controller/processor 359. In one configuration, the apparatus 1804 may be a processor chip (modem and/or application) and include just the cellular baseband processor 1824 and/or the application processor 1806, and in another configuration, the apparatus 1804 may be the entire UE (e.g., see UE 350 of FIG. 3) and include the additional modules of the apparatus 1804.

As discussed supra, the ranging component 197 may be configured to receive, from each wireless device in a set of wireless devices, a confidence metric related to a synchronization accuracy of the wireless device. The ranging component 197 may also be configured to estimate a position of the UE based on using one or more confidence metrics of one or more wireless devices in the set of wireless devices. The ranging component 197 may be within the cellular baseband processor 1824, the application processor 1806, or both the cellular baseband processor 1824 and the application processor 1806. The ranging component 197 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1804 may include a variety of components configured for various functions. In one configuration, the apparatus 1804, and in particular the cellular baseband processor 1824 and/or the application processor 1806, may include means for receiving, from each wireless device in a set of wireless devices, a confidence metric related to a synchronization accuracy of the wireless device. The apparatus 1804 may further include means for estimating a position of the UE based on using one or more confidence metrics of one or more wireless devices in the set of wireless devices.

In one configuration, the means for estimating the position of the UE based on using the one or more confidence metrics of the one or more wireless devices in the set of wireless devices may include configuring the apparatus 1804 to select the one or more wireless devices in the set of wireless devices for estimating the position of the UE based on their corresponding confidence metrics, and perform positioning of the UE based on using the selected one or more wireless devices.

In another configuration, the means for estimating the position of the UE based on using the one or more confidence metrics of the one or more wireless devices in the set of wireless devices may include configuring the apparatus 1804 to apply a synchronization error correction term for each measurement between the UE and each of the one or more wireless devices based on a corresponding confidence metrics of the each of the one or more wireless devices, and estimate the position of the UE based on a set of measurements between the UE and the one or more wireless devices.

In another configuration, the set of wireless devices includes at least one initiator anchor or synchronization anchor, and the UE is a mobile device or a tag.

The means may be the ranging component 197 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at first wireless device, comprising: transmitting, to a second wireless device, a set of parameters that includes at least one of: (1) a location accuracy of the first wireless device, (2) a ranging accuracy between the first wireless device and one or more wireless devices, (3) a clock stability of the first wireless device, (4) one or more hardware calibration errors associated with the first wireless device, or (5) a set of confidence metric formulation options; estimating a confidence metric related to a synchronization accuracy of the first wireless device based on at least one of the set of parameters; and transmitting the confidence metric for positioning of a user equipment (UE).

Aspect 2 is the method of aspect 1, further comprising: receiving, from the second wireless device based on the set of parameters, a second confidence metric related to a second synchronization accuracy of the second wireless device; and modifying at least one wireless device for the positioning of the UE based on the second confidence metric.

Aspect 3 is the method of aspect 1 or 2, wherein transmitting the confidence metric comprises transmitting the confidence metric to a server, the method further comprises: receiving, from the server based on the confidence metric, an indication to modify at least one wireless device for the positioning of the UE based on the confidence metric.

Aspect 4 is the method of any of aspects 1 to 3, wherein transmitting the confidence metric comprises: transmitting the confidence metric to at least one of the second wireless device, a server, or the UE.

Aspect 5 is the method of any of aspects 1 to 4, wherein the first wireless device is an initiator anchor or a synchronization anchor, the second wireless device is a responder anchor, and the UE is a mobile device or a tag.

Aspect 6 is the method of any of aspects 1 to 5, further comprising: receiving a plurality of confidence metrics from a plurality of wireless devices based on the set of parameters; and maintaining a record of confidence metrics for the plurality of wireless devices.

Aspect 7 is the method of any of aspects 1 to 6, further comprising: exchanging a set of ranging messages with the second wireless device until a threshold number of measurements is above a ranging figure of merit (FoM) threshold, wherein estimation of the confidence metric is further based on one or more measurements in the threshold number of measurements.

Aspect 8 is the method of any of aspects 1 to 7, wherein transmitting the set of parameters comprises: transmitting the set of parameters via a ranging control message (RCM) or an out-of-band (OOB) message.

Aspect 9 is the method of any of aspects 1 to 8, wherein transmitting the confidence metric comprises: transmitting the confidence metric via a downlink time different of arrival (TDoA) message (DTM).

Aspect 10 is the method of any of aspects 1 to 9, wherein the synchronization accuracy corresponds to a standard deviation of an error in a synchronization time.

Aspect 11 is an apparatus for wireless communication at a first wireless device, including: a memory; and at least one processor coupled to the memory and, based at least in part on information stored in the memory, the at least one processor is configured to implement any of aspects 1 to 10.

Aspect 12 is the apparatus of aspect 11, further including at least one of a transceiver or an antenna coupled to the at least one processor.

Aspect 13 is an apparatus for wireless communication including means for implementing any of aspects 1 to 10.

Aspect 14 is a computer-readable medium (e.g., a non-transitory computer-readable medium) storing computer executable code, where the code when executed by a processor causes the processor to implement any of aspects 1 to 10.

Aspect 15 is a method of wireless communication at a second wireless device, comprising: receiving, from a first wireless device, a set of parameters that includes at least one of: (1) a location accuracy of the first wireless device, (2) a ranging accuracy between the first wireless device and one or more wireless devices, (3) a clock stability of the first wireless device, (4) one or more hardware calibration errors associated with the first wireless device, or (5) a set of confidence metric formulation options; estimating a confidence metric related to a synchronization accuracy of the second wireless device based on at least one of the set of parameters; and transmitting the confidence metric for positioning of a user equipment (UE).

Aspect 16 is the method of aspect 15, further comprising: receiving, from the first wireless device based on the set of parameters, a second confidence metric related to a second synchronization accuracy of the first wireless device; and modifying at least one wireless device for the positioning of the UE based on the second confidence metric.

Aspect 17 is the method of aspect 15 or 16, wherein transmitting the confidence metric comprises transmitting the confidence metric to a server, the method further comprises: receiving, from the server based on the confidence metric, an indication to modify at least one wireless device for the positioning of the UE based on the confidence metric.

Aspect 18 is the method of any of aspects 15 to 17, wherein transmitting the confidence metric comprises: transmitting the confidence metric to at least one of the first wireless device, a server, or the UE.

Aspect 19 is the method of any of aspects 15 to 18, wherein the second wireless device is a responder anchor, the first wireless device is an initiator anchor or a synchronization anchor, and the UE is a mobile device or a tag.

Aspect 20 is the method of any of aspects 15 to 19, further comprising: receiving a plurality of confidence metrics from a plurality of wireless devices based on the set of parameters; and maintaining a record of confidence metrics for the plurality of wireless devices.

Aspect 21 is the method of any of aspects 15 to 20, further comprising: exchanging a set of ranging messages with the first wireless device until a threshold number of measurements is above a ranging figure of merit (FoM) threshold, wherein estimation of the confidence metric is further based on one or more measurements in the threshold number of measurements.

Aspect 22 is the method of any of aspects 15 to 21, wherein receiving the set of parameters comprises: receiving the set of parameters via a ranging control message (RCM) or an out-of-band (OOB) message.

Aspect 23 is the method of any of aspects 15 to 22, wherein transmitting the confidence metric comprises: transmitting the confidence metric via a downlink time different of arrival (TDoA) message (DTM).

Aspect 24 is the method of any of aspects 15 to 23, wherein the synchronization accuracy corresponds to a standard deviation of an error in a synchronization time.

Aspect 25 is an apparatus for wireless communication at a second wireless device, including: a memory; and at least one processor coupled to the memory and, based at least in part on information stored in the memory, the at least one processor is configured to implement any of aspects 15 to 24.

Aspect 26 is the apparatus of aspect 25, further including at least one of a transceiver or an antenna coupled to the at least one processor.

Aspect 27 is an apparatus for wireless communication including means for implementing any of aspects 15 to 24.

Aspect 28 is a computer-readable medium (e.g., a non-transitory computer-readable medium) storing computer executable code, where the code when executed by a processor causes the processor to implement any of aspects 15 to 24.

Aspect 29 is a method of wireless communication at a user equipment (UE), comprising: receiving, from each wireless device in a set of wireless devices, a confidence metric related to a synchronization accuracy of the wireless device; and estimating a position of the UE based on using one or more confidence metrics of one or more wireless devices in the set of wireless devices.

Aspect 30 is the method of aspect 29, wherein estimating the position of the UE based on using the one or more confidence metrics of the one or more wireless devices in the set of wireless devices comprises: selecting the one or more wireless devices in the set of wireless devices for estimating the position of the UE based on their corresponding confidence metrics; and performing positioning of the UE based on using the selected one or more wireless devices.

Aspect 31 is the method of aspect 29 or 30, wherein estimating the position of the UE based on using the one or more confidence metrics of the one or more wireless devices in the set of wireless devices comprises: applying a synchronization error correction term for each measurement between the UE and each of the one or more wireless devices based on a corresponding confidence metrics of the each of the one or more wireless devices; and estimating the position of the UE based on a set of measurements between the UE and the one or more wireless devices.

Aspect 32 is the method of any of aspects 29 to 31, wherein the set of wireless devices includes at least one initiator anchor or synchronization anchor, and the UE is a mobile device or a tag.

Aspect 33 is an apparatus for wireless communication at a second wireless device, including: a memory; and at least one processor coupled to the memory and, based at least in part on information stored in the memory, the at least one processor is configured to implement any of aspects 29 to 32.

Aspect 34 is the apparatus of aspect 33, further including at least one of a transceiver or an antenna coupled to the at least one processor.

Aspect 35 is an apparatus for wireless communication including means for implementing any of aspects 29 to 32.

Aspect 36 is a computer-readable medium (e.g., a non-transitory computer-readable medium) storing computer executable code, where the code when executed by a processor causes the processor to implement any of aspects 29 to 32.

What is claimed is:

1. An apparatus for wireless communication at a first wireless device, comprising:
at least one memory; and
at least one processor coupled to the at least one memory, wherein the at least one processor is configured to:
transmit, to a second wireless device, a set of parameters that includes at least one of: (1) a location accuracy of the first wireless device, (2) a ranging accuracy between the first wireless device and one or more wireless devices, (3) a clock stability of the first wireless device, (4) one or more hardware calibration errors associated with the first wireless device, or (5) a set of confidence metric formulation options;
estimate a confidence metric related to a synchronization accuracy of the first wireless device based on at least one of the set of parameters; and
transmit the confidence metric for positioning of a user equipment (UE).

2. The apparatus of claim 1, wherein the at least one processor is further configured to:
receive, from the second wireless device based on the set of parameters, a second confidence metric related to a second synchronization accuracy of the second wireless device; and
modify at least one wireless device for the positioning of the UE based on the second confidence metric.

3. The apparatus of claim 1, wherein to transmit the confidence metric, the at least one processor is configured to transmit the confidence metric to a server, and wherein the at least one processor is further configured to:
receive, from the server based on the confidence metric, an indication to modify at least one wireless device for the positioning of the UE based on the confidence metric.

4. The apparatus of claim 1, wherein to transmit the confidence metric, the at least one processor is configured to:
transmit the confidence metric to at least one of the second wireless device, a server, or the UE.

5. The apparatus of claim 1, wherein the first wireless device is an initiator anchor or a synchronization anchor, the second wireless device is a responder anchor, and the UE is a mobile device or a tag.

6. The apparatus of claim 1, wherein the at least one processor is further configured to:
receive a plurality of confidence metrics from a plurality of wireless devices based on the set of parameters; and
maintain a record of confidence metrics for the plurality of wireless devices.

7. The apparatus of claim 1, wherein the at least one processor is further configured to:
exchange a set of ranging messages with the second wireless device until a threshold number of measurements is above a ranging figure of merit (FoM) threshold, wherein estimation of the confidence metric is further based on one or more measurements in the threshold number of measurements.

8. The apparatus of claim 1, wherein to transmit the set of parameters, the at least one processor is configured to:
transmit the set of parameters via a ranging control message (RCM) or an out-of-band (OOB) message.

9. The apparatus of claim 1, wherein to transmit the confidence metric, the at least one processor is configured to:
transmit the confidence metric via a downlink time different of arrival (TDoA) message (DTM).

10. An apparatus for wireless communication at a second wireless device, comprising:
at least one memory; and
at least one processor coupled to the at least one memory, wherein the at least one processor is configured to:
receive, from a first wireless device, a set of parameters that includes at least one of: (1) a location accuracy of the first wireless device, (2) a ranging accuracy between the first wireless device and one or more wireless devices, (3) a clock stability of the first wireless device, (4) one or more hardware calibration errors associated with the first wireless device, or (5) a set of confidence metric formulation options;
estimate a confidence metric related to a synchronization accuracy of the second wireless device based on at least one of the set of parameters; and
transmit the confidence metric for positioning of a user equipment (UE).

11. The apparatus of claim 10, wherein the at least one processor is further configured to:
receive, from the first wireless device based on the set of parameters, a second confidence metric related to a second synchronization accuracy of the first wireless device; and
modify at least one wireless device for the positioning of the UE based on the second confidence metric.

12. The apparatus of claim 10, wherein to transmit the confidence metric, the at least one processor is configured to transmit the confidence metric to a server, and wherein the at least one processor is further configured to:
receive, from the server based on the confidence metric, an indication to modify at least one wireless device for the positioning of the UE based on the confidence metric.

13. The apparatus of claim 10, wherein to transmit the confidence metric, the at least one processor is configured to:
transmit the confidence metric to at least one of the first wireless device, a server, or the UE.

14. The apparatus of claim 10, wherein the at least one processor is further configured to:
receive a plurality of confidence metrics from a plurality of wireless devices based on the set of parameters; and
maintain a record of confidence metrics for the plurality of wireless devices.

15. The apparatus of claim 10, wherein the at least one processor is further configured to:
exchange a set of ranging messages with the first wireless device until a threshold number of measurements is above a ranging figure of merit (FoM) threshold, wherein estimation of the confidence metric is further based on one or more measurements in the threshold number of measurements.

16. The apparatus of claim 10, wherein to receive the set of parameters, the at least one processor is configured to:
receive the set of parameters via a ranging control message (RCM) or an out-of-band (OOB) message.

17. The apparatus of claim 10, wherein to transmit the confidence metric, the at least one processor is configured to:
transmit the confidence metric via a downlink time different of arrival (TDoA) message (DTM).

18. An apparatus for wireless communication at a user equipment (UE), comprising:
at least one memory; and
at least one processor coupled to the at least one memory, wherein the at least one processor is configured to:
receive, from each wireless device in a set of wireless devices, a confidence metric related to a synchronization accuracy of the wireless device; and
estimate a position of the UE based on using one or more confidence metrics of one or more wireless devices in the set of wireless devices.

19. The apparatus of claim 18, wherein to estimate the position of the UE based on using the one or more confidence metrics of the one or more wireless devices in the set of wireless devices, the at least one processor is configured to:
select the one or more wireless devices in the set of wireless devices for estimating the position of the UE based on their corresponding confidence metrics; and
perform positioning of the UE based on using the selected one or more wireless devices.

20. The apparatus of claim 18, wherein to estimate the position of the UE based on using the one or more confidence metrics of the one or more wireless devices in the set of wireless devices, the at least one processor is configured to:
apply a synchronization error correction term for each measurement between the UE and each of the one or more wireless devices based on a corresponding confidence metrics of the each of the one or more wireless devices; and
estimate the position of the UE based on a set of measurements between the UE and the one or more wireless devices.
